(19) United States
(12) Patent Application Publication
(10) Pub. No.: US 2006/0066846 A1
(43) Pub. Date: Mar. 30, 2006

(54) Apparatus and method for detection of contaminant particles or component defects

(75) Inventors: Ching-Too Chen, Chandler, AZ (US); Roger Brueckner, Phoenix, AZ (US); Jim Hopkins, Mesa, AZ (US); Amy Yang, Gilbert, AZ (US); Craig Albright, Gilbert, AZ (US); Arnold Klugman, Friendsville, TN (US)

Correspondence Address: PILLSBURY WINTHROP SHAW PITTMAN, LLP, P.O. BOX 10500, MCLEAN, VA, 22102, US

(73) Assignee: TELCO TESTING SYSTEMS, LLC, Tempe, AZ (US)

(21) Appl. No.: 11/234,392

(22) Filed: Sep. 26, 2005

Related U.S. Application Data
(60) Provisional application No. 60/613,728, filed on Sep. 29, 2004.

(51) Int. Cl. G01N 21/88

(52) U.S. Cl. 356/239.1

(57) ABSTRACT

An apparatus is described for detecting particulates on or defects in a transparent media. The apparatus includes a light source, and an array of light-sensitive elements, each of which produce an electrical signal indicating a characteristic value based on light incident on the element. The first array is disposed a predetermined distance from the at least one light source so that the transparent media may be placed between the light source and the array. An addressing circuit reads the characteristic values produced by each element, and an analog-to-digital converter circuit digitizes the characteristic values, producing digitized values. A processor processes the digitized values to determine whether a particle or defect is present at least based on a position of the shadow cast by the particle or defect on the array. A method for detecting a particulate or defect on or in a transparent media is also described.

### CROSS REFERENCE TO RELATED APPLICATIONS

This application relies for priority on U.S. Provisional Patent Application No. 60/613,728, filed Sep. 29, 2004, the entirety of which is incorporated herein by reference.

### FIELD OF THE INVENTION

The present invention relates to an apparatus and method for determining the contamination of or defects associated with transparent media, including optical components.

### BACKGROUND OF THE INVENTION

Many consumer electronic products, such as, digital cameras, cell phones, etc., employ CMOS image sensors (CIS) and a variety of associated optical components. As such, product operation and performance may depend on the existence of contaminant particles and/or defects on the optical components. Moreover, in CIS-based assemblies, such particles and/or defects are, in many cases, very small and difficult to identify.

Existing approaches for detecting contaminant particles and/or component defects include human detection, employing lighted optical magnifiers as well as conventional camera assemblies. According to recent marketing observations, neither approach appears to work with any significant degree of success. This is due, in large part, to the fact that conventional detection approaches have difficulty in detecting and processing contaminating particulates below a threshold size. For example, conventional detection schemes employing charged-coupled devices (CCDs) and associated optical magnifiers have significant problems detecting particulates that are small in size.

As such, traditional manufacturing practices for CIS-based assemblies face new challenges with respect to cleanliness and handling, especially since current manufacturing techniques require a rapid detection of small particles.

### SUMMARY OF THE INVENTION

The principles of the present invention, as embodied and broadly described herein, provide an apparatus and method for detecting contaminant particles and/or defects of optical components.

It is one aspect of the invention to provide an apparatus includes at least one light source. A first array of light-sensitive elements is provided where each of the elements are configured to produce an electrical signal indicating a characteristic value based on light incident on the element. The first array is disposed a predetermined distance from the at least one light source, thereby permitting positioning of the transparent media between the at least one light source and the first array. An addressing circuit is configured to read the characteristic values produced by each element. An analog-to-digital converter circuit is configured to digitize the characteristic values, thereby producing digitized values. A processor is configured to process the digitized values to determine whether a particle or defect is present. The at least one light source is configured to produce light to illuminate the particle or defect. During detection, the first array receives the light passing through the transparent media and a shadow cast by the particle or defect, and the processor determines whether the particle or defect is present based at least on a position of the shadow cast by the particle or defect on the first array.

It is another object of the invention to provide a method for detecting one or more particles on or defects in a transparent media. The method includes positioning the transparent media between at least one light source and a first array of light-sensitive elements in which each of the elements are configured to produce electrical signals indicating a value characteristic based on light incident on the element. The method also includes illuminating the light source, thereby causing light to pass through the transparent element to cast a light image on the first array and also to cause the particle or defect to cast a shadow on the first array. The method also includes processing the electrical signals to evaluate whether the particle or the defect is present based at least on a position of the shadow on the first array.

Still another aspect of the invention to provide an apparatus that also detects the size and location of a particle on or a defect in the transparent media using the shadow cast by the particle or defect.

Yet another aspect of the invention to provide an apparatus that also detects a reflected image from a particle on or a defect in the transparent media to assist in determining the presence or absence of the particle or defect.

It is another aspect of the invention to provide an apparatus that also detects the size and location of a particle on or a defect in the transparent media using the reflected image cast by the particle or defect.

It is still another aspect of the invention to provide a method that also includes the detection of the size and location of a reflected image from a particle on or a defect in the transparent to assist in determining the presence or absence of the particle or defect.

Yet another aspect of the invention provides an apparatus that determines the size and location of the particle or defect based on the data generated concerning that particle or defect.

One further aspect of the invention provides a method for determining the size and location of the particle based on the data generated concerning the particle or defect.

Still another aspect of the invention is to provide multiple light sources that are used to determine the presence, size, and/or location of the particle or defect.

An additional aspect of the invention provides a method for determining the size and location of the particle or defect based on the data generated by the multiple light sources.

Other aspects of the invention will be made apparent from the discussion that follows and the drawings appended hereto.

### BRIEF DESCRIPTION OF THE DRAWINGS

The present invention will be described with reference to drawings, in which:

FIG. 1 depicts a cross-sectional view of a CIS-based assembly, in accordance with an embodiment of the present invention;

FIG. 2 illustrates a simplified model for particulate and defect detection, in accordance with an embodiment of the present invention;

FIGS. 3A and 3B illustrate a simplified model for particulate and defect detection, in accordance with another embodiment of the present invention;

FIG. 4 depicts a block diagram representation for an apparatus for particulate and defect detection, in accordance with an embodiment of the present invention;

FIG. 5 illustrates a simplified model for particulate and defect detection in accordance with yet another embodiment of the present invention; and

FIG. 6 illustrates a model for particulate and defect detection in accordance with still another embodiment of the invention.

### DESCRIPTION OF THE INVENTION

For the sake of clarity and brevity, embodiments of the present invention will now be described within the context of detecting contaminant particles and/or defects of optical media. However, artisans of ordinary skill will readily appreciate that the disclosed embodiments are not limited to such applications, as the present invention is contemplated to be practiced in other applications and technological areas, such as, electronics, biology, biotechnology, test mediums, gemology, fluids, vapor-deposited mediums, transparent sheet materials, such as glass or plastic, and any other applications associated with transparent media.

Specifically, embodiments of the invention are directed toward detecting contaminant particles or defects associated with any transparent media. For purposes of the invention, a transparent media encompasses a broad spectrum of materials. With respect to the embodiments described herein the transparent media include the optical components associated with a CIS-based assembly 10, which is described in greater detail below. Optical components of the CIS-based assembly include, but are not limited to a CIS die 12, an infra-red glass absorptive glass (“IR glass”) 20, a lens 24, and a Bayer filter 26. Other optical components also are intended to fall within the scope of transparent media, as would be appreciated by those skilled in the art.

In addition, transparent media are intended to encompass and light-transmitting media including those that are transparent, such as optical components, or those that are translucent, which means that some of the light may not pass entirely through the transparent media. A frosted sheet of glass or an liquid crystal display (“LCD”) two examples of translucent materials that are intended to fall within the scope of the present invention.

Other materials that fall within the scope of “transparent media” include sheets of transparent materials, for example, sheets of glass or plastic, including plastic films. In addition, fluids and semi-fluid materials are intended to fall within the scope of transparent media. For example, the present invention may be applied to detect the suspended particles within a fluid or a gel. Also, the present invention may be applied to detect particles within a plasma or a gas.

As may be appreciated by those skilled in the art, the present invention is intended to apply to any material where light passes through the material. Such materials are intended to fall within the scope of the term “transparent media.” The discussion with respect to this term is not intended to be limiting of the invention. The listing of materials that fall within the scope of “transparent media” is meant to be illustrative of the broad application of the present invention for the detection of particles, particle sizes, the location of particles, defects, defect sizes, defect locations, aberrations, aberration sizes, and aberration locations present on or in the transparent media.

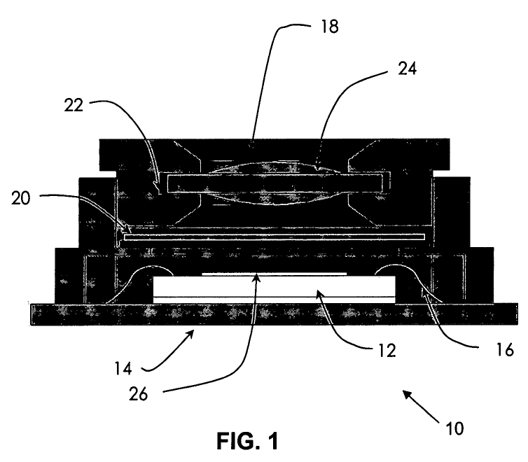

Turning now to one exemplary embodiment of the invention, FIG. 1 depicts a cross-sectional view of a CIS-based assembly 10. As shown in FIG. 1, a CIS die 12 is attached to a substrate 14. Wire bonds 16 electrically connect bonding pads of the CIS die 12 to designated pads on the substrate 14. A housing 18, which includes infrared absorptive glass 20, is fastened to the substrate 14. The housing 18 preferably is made of plastic, but other materials may be used as would be appreciated by those skilled in the art. The IR glass 20 absorbs infrared light to reduce the intensity of IR light on the CIS die 12, thereby improving the image quality produced by the CIS die 12, as would be appreciated by those skilled in the art. A lens barrel 22 is fitted into the housing 18, adjusted to a proper focus distance, and is permanently secured into the housing 18 in a preferred embodiment of the invention. A Bayer filter 26 may overlay the CIS die 12, as would be appreciated by those skilled in the art and as discussed in greater detail below.

Referring to FIG. 1, generally there are a finite number of possible regions where contamination particulates or defects could reside: on the lens 24 (in the lens barrel 22), on the IR glass 20 (in the housing 18), on the Bayer filter 26, or on the CIS die 12 itself. Of course, the particles or defects could be on the top surface of the components, the bottom surface of the components, and even within the component (e.g., imperfections in the optical media capable of causing deformations and aberrations of an image). For example, the defect could be a scratch on the surface of the component or an inclusion, such as a bubble, within the component. It will be appreciated, however, that for multi-component assemblies, the contamination or defects may reside on any of the optical planes along the optical path. Moreover, the present invention may be used where more than one optical plane is included in the optical path.

Moreover, certain operational assumptions may be relied upon. For example, since the particulates may have escaped detection by human inspection (aided perhaps by conventional, lighted magnifiers), they are probably smaller than a given threshold size. Additionally, the particulates probably come from the surrounding environment or some of the assembly materials, particularly during assembly of the various components of the CIS-based assembly 10. Dirt and dust are likely suspects as well as plastic chips or flashing from the housing and/or lens barrel. Finally, the particulate is presumed be loose, so that it is not securely adhered to the surface(s) in question.

To unambiguously identify defects (and their sources), testing should take place in successive manufacturing stages. Of course, the guiding strategy is still to identify defects as quickly as possible to minimize the cost of failed product and allow possible cleaning of the contaminated assembly subunit. In addition, multiple test stages, judiciously placed in the manufacturing flow, provide a measure of process quality.

It will be appreciated that the degree of degradation depends upon the particulate size and position. Large particles located close to the Bayer filter 26 (also referred to as a “microlens” by those skilled in the art) cause significant yield issues in manufacturing while small particles that are far away from the Bayer filter 26 (or microlens) pose less of a problem.

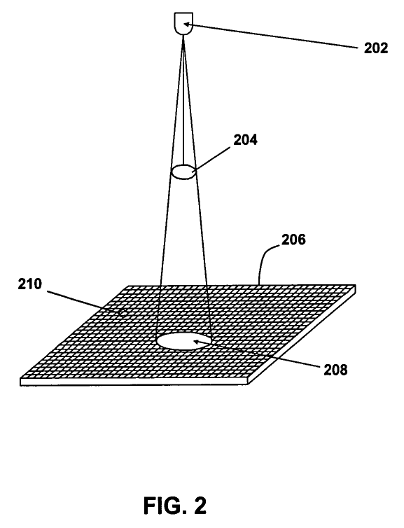

With this said, FIG. 2 illustrates a simplified model for particulate and defect detection, in accordance with an embodiment of the present invention. As indicated in FIG. 2, a single-point light source 202 provides illumination. It will be appreciated that such a light source may comprise a Light Emitting Diode (LED), laser, or other similarly configured light sources suitable for such purposes and that the illumination comprises the radiation of visible and non-visible electromagnetic spectra, such as, RF (radio frequency), UV (ultra violet), IR, near-IR, etc.

For example, when testing the CIS device 10, a hemispherical RGB (red-green-blue) light source that operates in either point-source or uniform may be used. In this manner, when performing full testing of CIS device 10 and associated components, the RGB light source in a uniform illumination mode to provide even light intensity across the face of a sensor device. As would be appreciated by those skilled in the art, the light source need not be limited to a particular wavelength or particular wavelengths of visible light.

In addition, it is contemplated that the light source may be either a continuous light source or a modulated light source. A continuous light source provides a steady, or continuous, illumination. A modulated light source is one which is strobed, meaning that the light flashes at a particular frequency. If the light source is modulated, the frequency may be steady, e.g., 60 Hz, or the frequency may be modified in a particular pattern as would be appreciated by those skilled in the art. While reference is made to a “light source” herein, it is to be understood that both unmodulated and modulated light sources are envisioned for use with the invention.

In one contemplated embodiment, the light source 202 may be configured to produce uniform Device Under Test (“DUT”) illumination by activating the LED ring around the circumference of the hemispherical dome. Because of multiple reflective paths in the dome as well as the light funnel, the illumination uniformity for a typical DUT (0.27″×0.27″) is better than 99%. Across a 0.75″ diameter, the uniformity exceeds 98%.

However, for particle detection to be effective, sensing the edges of the particles is preferred. To sense the edge of the particles, it is preferred to use collimated light rather than a uniform light source. While a laser (or similar collimated light generator) may be used, such light sources may not be cost effective in every testing environment. Accordingly, a single LED located at the dome's apex (of the uniform light source) may be relied upon for particle detection. For the sake of simplicity, FIG. 2 omits the dome cross-section and RGB light, showing only the point light source at the dome's apex. As would be appreciated by those skilled in the art, a dome around the light source is not needed to practice the invention.

To facilitate an understanding of the invention, the invention will first be described in connection with the use of a single point light source. Next, the invention will be described in connection with multiple point light sources.

As illustrated in FIG. 2, positioned opposite to the single point light source 202, is an array of light-sensitive picture elements (i.e., pixels) 206, wherein each element or pixel 210 produces an electrical signal having properties that represent characteristics of the light incident on the pixel 210, such as, for example, intensity. In one embodiment, the array 206 comprises a CMOS image sensor (“CIS”) array. In particular, the CIS array 206 may comprise an array of identical photodiodes. To make the individual photodiodes respond to the red, green, or blue (i.e., RGB) portions of the light spectrum, each individual imaging element (i.e., pixel) may be covered with a colored filter, such as, for example, a Bayer filter 26, which allows only light within a defined spectral band to reach the photodiode.

In FIG. 2, each rectangle represents an individual pixel 210. Typical dimensions for each pixel 210 of the CIS array 206 may be about 5 μm×5 μm and about 10 μm×10 μm. For certain applications, pixel dimensions of about 3.4 μm×3.4 μm are preferred. However, consistent with the embodiments of the present invention, it is certainly contemplated that pixel 210 dimensions of about 1.0 μm×1.0 μm or less can and will be employed. Moreover, as will be appreciated, the present invention does not require reliance on particular pixel dimensions, and each manufacturing environment may have different requirements.

In the embodiment shown in FIG. 2, somewhere between the light source 202 and the CIS array 206, such as, for example, on or within the lens 24, on or within the IR glass 20, or on the array 206 surface itself, a contamination particulate 204 is present. Given the configuration described and depicted, any contaminant particulate 204 between the light source 202 and the array 206 casts a shadow onto the surface of the array 206 when the light source 202 is illuminated.

The shadow introduces a dark region on the array 206, which affects the electrical signal characteristic values generated by the pixels of the array 206 corresponding to the darker regions. The electrical signals may then be processed to provide a collection or map of CIS pixel data. The pixel data may then be used to detect the presence of the particulate 204.

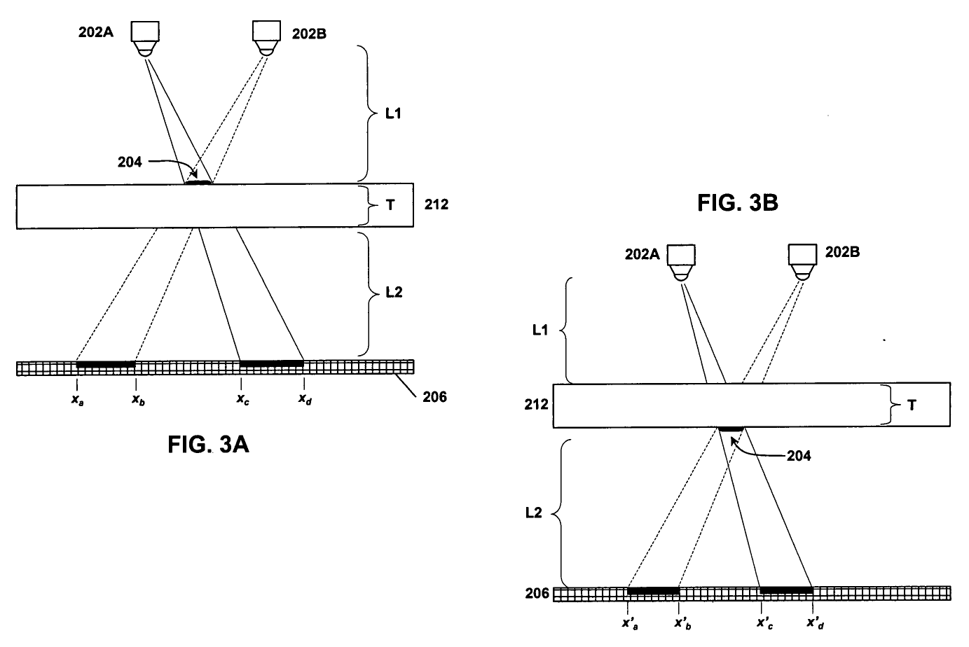

FIGS. 3A and 3B illustrate a simplified model for particulate and defect detection and position identification, in accordance with another embodiment of the present invention. In certain instances, it may be advantageous to isolate the particle contaminant or defect to a specific surface or optical plane, such as, for example, the upper or lower surfaces of the IR glass 20. To achieve this purpose, the light source position is dynamically altered by employing two single-point light sources 202A, 202B.

By way of example, consider an optical component 212 (such as the IR glass 20) to be inspected having a contaminating particulate 204 on the upper surface thereof. In the depicted embodiment of FIG. 3A, the optical component 212 is inserted between the two single-point light sources 202A, 202B and the array of light-sensitive pixels 206, such as, for example, the CIS array 206. As shown in the figure, the optical component 212 is at a fixed distance L1 from the two single-point light sources 202A, 202B and at a fixed distance L2 from the CIS array 206. As illustrated, the optical component 212 has a thickness, T. In the illustrated embodiment, for ease of this discussion, the optical element 212 is planar on both sides. Accordingly, the thickness T is uniform. As would be appreciated by those skilled in the art, however, an optical component 212 with a uniform thickness T is not required to practice the present invention. As would be understood by those skilled in the art, if the optical element 212 is a lens, such as lens 24, one or both of the top and bottom surfaces may be concave or convex. Therefore, the thickness will vary.

To practice the present invention, it is preferred that the optical component 212 be positioned so that the optical component 212 is substantially parallel to the CIS array 206. As would be appreciated by those skilled in the art, however, this orientation is not required.

Returning to FIGS. 3A and 3B, the two single-point light sources 202A, 202B are successively activated to provide illumination. The illumination of the single-point light source 202B and the presence of particulate 204 results in the casting of a shadow spanning demarcation points xₐ-x_{b} on the CIS array 206. Similarly, the illumination of single-point light source 202A and the presence of particulate 204 results in the casting of a casts a shadow spanning demarcation points x_{c}-x_{d} on the CIS array 206. While the figures illustrate one dimension of the shadow for ease of discussion, those skilled in the art would readily recognize that the shadow will be cast in two dimensions in most cases. The present invention recognizes and evaluates the shadow in one or both dimensions, as appropriate, as would be appreciated by those skilled in the art.

In contrast, consider the same optical component 212 with the same configuration having, instead, the contaminating particle 204 on the lower surface thereof. Upon successively activating the two single-point light sources 202A, 202B, shadows are cast spanning demarcation points x′ₐ-x′_{b} and x′_{c}-x′_{d}, which are at least partially different than demarcation points xₐ-x_{b} and x_{c}-x_{d}, respectively. This is because, given the geometry of the depicted configuration, the lateral location of the single point light sources 202A, 202B, shifts the shadow on the CIS array 206. This measurable degree of shadow shifting or movement facilitates calculation of the vertical position of the particulate 204. For purposes of this discussion, it should be understood that the shadows cast between xₐ-x_{b} and x_{c}-x_{d} are intended to refer, generically, to two shadows cast by the particle 204 regardless of its location.

In addition, using this methodology, the location of the particulate 204 may be detected on the optical component 212. Since the optical component 212 has a width and a depth (the depth being into the page on which FIGS. 3A and 3B are printed), the location of the shadow(s) 208 cast onto the CIS array 206 also generate information that permits calculation of the size and/or the location of the particulate 204 on the optical component in the depth direction.

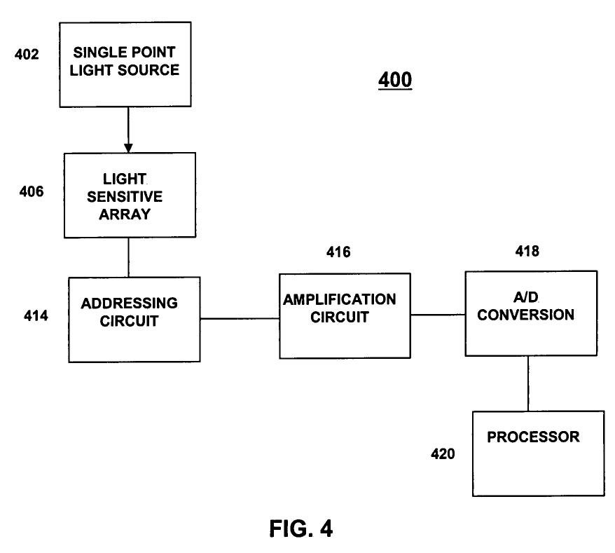

FIG. 4 depicts a block diagram representation of an apparatus for particulate and defect detection, in accordance with an embodiment of the present invention. As shown in FIG. 4, the apparatus 400 comprises at least one single point light source 402 and a light sensitive array 406, as described above. The apparatus 400 further comprises an addressing circuit configured to read the characteristic values of electrical signal produced and accumulated by each pixel or photodiode location due to the light incident upon each pixel of the light sensitive array 406. As noted above, the characteristic value of electrical signal produced by each pixel may be an intensity value.

The apparatus 400 also comprises an amplification circuit 416, configured to amplify characteristic values of the electrical signal produced and accumulated. The amplified characteristics are then supplied to an analog-to-digital converter circuit 418 to digitize the values to provide a map of the digitized values. In certain embodiments, the values may be digitized to have a resolution of about 2⁸ to 2¹² values. The values are then supplied to a processor 420, which processes the digitized values to provide the detection and/or location identification of the particulate or defect 204 of the optical component being tested.

Test trials employing the apparatus 400 and related embodiments thereof have indicated processing times of about 1 sec. to detect particulates that are 3.4 μm in size or more. And, for the detection of particulates that are 10 μm in size or more, processing times are reduced to approximately 0.25 seconds.

It will be appreciated that the configurations and orientations of the described embodiments are not meant to be exclusive. For example, depending upon the item being manufactured as well as the phase of the manufacturing process, the CIS die may be part of the test equipment or part of the item being tested. In a standalone IR glass tester, the CIS device may be included in the tester to create the necessary sensing element. When testing CIS-based assemblies, the tester will access the CIS die that forms part of the device-under-test. Either way, the particle detection concept is the same.

Along these lines, consistent with the present invention, a test unit may comprise the light sensitive array 406 integrated and sealed with an optical component, such as IR glass 20. The light sensitive array 406 would be pre-tested to ensure the proper operation of each pixel and cleaned to ensure the absence of any particulate greater than a certain size. The IR glass 20 would also be cleaned to ensure the absence of any particulate greater than a certain size. The light sensitive array 406 and the IR glass 20 would then be combined and secured together to achieve an integrated, sealed unit that is virtually particulate-free for a given particulate size. With this configuration, the test unit is optimized to detect particulates of a given size on an optical component without the need to confirm whether the particulate is on the array 406. The optimized test unit may be referred to as the “golden unit” since the test unit is, for purposes of the test, 100% particle-free and all of its associated pixels are operational. The golden unit may be used to calibrate the test equipment, as would be appreciated by those skilled in the art.

Moreover, it is noted that the orientation depicted in FIGS. 2, 3A, 3B, which shows the single point light source at the top and the CIS die 12 at the bottom, is not, in any way, to be limiting of the present invention. If the manufacturing processes allows, a reverse orientation, such as by placing the CIS die 12 at the top, may be more desirable, as such a configuration may help prevent particulates from accumulating on the CIS die 12 surface. Moreover, for purposes of referring to the optical component 212 in FIGS. 3A and 3B, the designations of “top” and “bottom” surfaces are arbitrary. If the optical component 212 were vertically oriented, the “top” and “bottom” surfaces would refer to the lateral surfaces (i.e., the right and left side surfaces) of the lens in its vertical orientation. The use of “top” and “bottom” are therefore, not intended to be restrictive of the present invention but are merely relied upon to simplify the discussion of the invention.

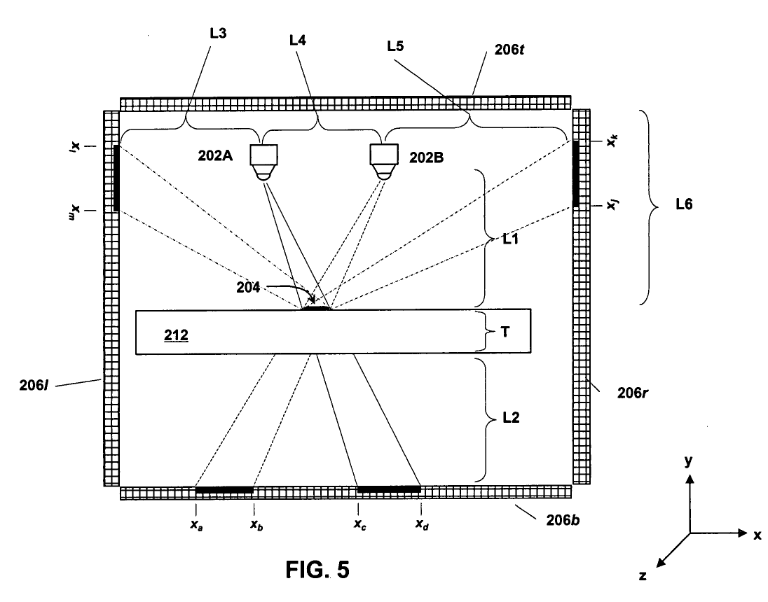

The present invention also is intended to encompass the detection of particles and defects by combining detection of the creation of a shadow as well as the detection of an image reflected from the particle or the defect. FIG. 5 is illustrative of this embodiment.

FIG. 5 illustrates one embodiment contemplated for the invention to detect not only the shadows cast by a particle 204 but also to detect the images reflected by the same particle 204. FIG. 5 illustrates a construction similar to that of FIGS. 3A and 3B. As is apparent in the figure, additional light sensitive arrays 206r, 206t, and 206l have been added. The bottom light sensitive array 206 has been labeled as “206b″ for ease of reference. For ease pf reference, the labels “b”, “l”, “r”, and “t” are intended to refer to “bottom”, “left”, “right”, and “top” orientations for the light sensitive arrays. As illustrated, the light sensitive arrays 206b and 206t are arranged so that the two arrays are substantially parallel to the orientation of the optical component 212. Also as shown, the arrays 206r and 206l are arranged so that they are substantially perpendicular to the orientation of the optical component 212. The orientation of the four arrays 206b, 206r, 206t, and 206l in FIG. 5 is meant to be illustrative only. Other orientations are possible, as would be appreciated by those skilled in the art.

As shown in FIG. 5, when the light source 202A is illuminated, not only will the particle 204 cast a shadow x_{c}-x_{d} on the array 206b, it also may create a reflected image xⱼ-xₖ to be cast on the array 206r. Similarly, when the light source 202B is illuminated, not only will a shadow xₐ-x_{b} be cast on the array 206b, but a reflected image xₗ-xₘ may be cast from the particle 204 on the array 206l. As would be appreciated by those skilled in the art, the reflected images xⱼ-xₖ, xₗ-xₘ would be cast only if the particle 204 does not absorb the impingent light. In such a case, only the shadows xₐ-x_{b}, x_{c}-x_{d} would be cast.

In the embodiment illustrated, no image or shadow is cast on the array 206t. While the illustrated embodiment does not show this result, it is contemplated that the array 206t will cooperate with the other arrays 206b, 206r, and 206l to provide the data required by the processor 420 to determine the size and location of the particle 204. Reflections may be cast on the array 206t depending on the angle of incidence on the particle 204, as would be appreciated by those skilled in the art.

As also shown in FIG. 5, when four arrays 206b, 206r, 206t, and 206l are employed, there are distances that are considered by the processor 420 to determine the location and size of the particle. Specifically, in addition to the variables discussed in connection with FIGS. 3A and 3B, the processor 420 may require the distance L3 of the light source 202A to the array 206l, the distance L4 between the light sources 202A, 202B, the distance L5 from the light source to the array 206r, and the distance L6 from the top surface of the optical component 212 to the array 206t. Other variables also may be employed, as would be appreciated by those skilled in the art to measure the size and location of the particle 204 (or defect). Those variables are defined by the optics and/or physics of the detection device, as would be appreciated by those skilled in the art.

It is contemplated that, when the processor 420 uses both the transmission of light and the reflection of light to determine the size and location of the particle 204 or defect, the processor 420 may also determine the thickness of the particle 204 or defect. The thickness of the particle 204 also may be calculated by the processor using only one of the transmission of light or the reflectance of light, depending on the signals generated by one or more of the arrays 206b, 206r, 206t, and 206l, as would be appreciated by those skilled in the art.

With respect to the detection of the particle 204 or defect using the transmission of light through the transparent media (i.e., the optical component 212), the processor 420 may rely solely on the information concerning the transmission of light through the transparent media to determine the size and location of the particle 204 or defect. Alternatively, the processor 420 may rely solely on the information concerning the shadow cast by the particle 204 or defect. Alternatively still, the processor 420 may rely on the combined signals from the array 206 that includes both the information concerning the light transmitted through the transparent media and the information concerning the shadow cast by the particle 204 on the array 206. The latter is preferred, but not required, to practice the invention.

With respect to the detection of the particle 204 or defect using the reflection of light from the particle 204 or the defect, the processor 420 may rely solely on the information concerning the light reflected from the particle 204 or defect to determine the size and location of the particle 204 or defect. Alternatively, the processor 420 may rely solely on the information associated with the absence of a reflection from the particle 204 or defect to determine its size and location. Alternatively still, the processor 420 may rely on the combined signals from the array 206 that includes both the information concerning the light reflected and not reflected from the particle 204. The latter is preferred but not required to practice the invention.

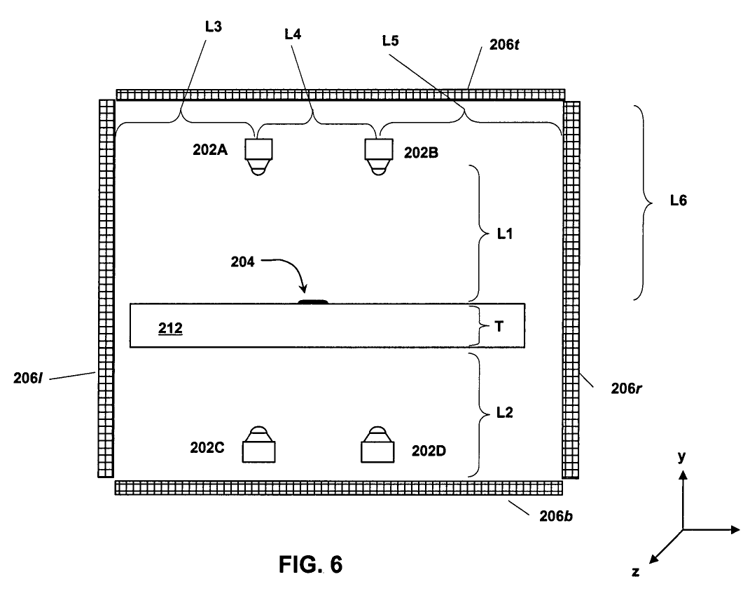

FIG. 6 illustrates one additional embodiment of the present invention. Specifically, two additional light sources 202C and 202D are included. The light sources 202C, 202D may be used in conjunction with the light sources 202A, 202B to generate further shadows and reflected images, thereby providing additional data to the processor 420 to determine the size and location of the particle 204. In this embodiment, by illuminating the light sources 202A, 202B, 202C, and 202D sequentially, significant data concerning the particle 204 may be collected and processed by the processor 204. In this embodiment, the shadows cast by the light sources 202A, 202B, 202C, 202D may be used, as discussed above. In addition, the reflected images from the particle 204 also may be used, as discussed above.

In FIGS. 5 and 6, the arrays 206b, 206r, 206t, and 206l are shown in a preferred orientation. Namely, it is anticipated that edges of the arrays 206b, 206r, 206t, and 206l will be in close proximity to one another to form a closed box. However, such a configuration is not required to practice the invention, as would be appreciated by those skilled in the art. In FIGS. 5 and 6, only the x and y dimensions are depicted. It is expected that arrays may be positioned on all six sides of the box, including the z dimension, to capture shadow and reflected image data from all directions, as would be appreciated by those skilled in the art.

In addition, the embodiments of the present invention may be practiced and configured to operate in a continuous manner. In other words, not only can the present invention be practiced by performing the detection of discrete optical components, it is also contemplated that the present invention may easily be adapted to continuously monitor any type of transparent media. If, for example, the present invention were employed to detect particles or defects in a continuous plastic sheet, the processor 420 may also be provided with a speed v of the plastic sheet to permit the processor 420 to calculate the length of the defect, as would be appreciated by those skilled in the art.

It is noted that the invention lies both in the detection of parameters associated with the shadow cast by the particle or defect or the reflected image cast by the same particle or defect. With respect to the detection of the shadow, the processor 420 may rely on the data generated by the shadow or the data generated by the light impingent upon the array 206. In other words, the detection of the size and location of the shadow may be accomplished by analyzing data generated by pixels 210 which have a low intensity value (i.e., little or no impingent light). The detection of the shadow also may be accomplished by analyzing those pixels 210 that produce data indicating that light is impingent thereon, which would be a higher intensity value, comparatively. The size and location of the shadow also may be determined using the entirety of the data generated by the array 206 (i.e., both the presence and absence of light). The same analysis may be used concerning the reflected image. Both the presence or absence of impingent light may be used or the entire set of data from the array may be used. The present invention contemplates reliance on all three types of analyses in addition to others that will be appreciated by those skilled in the art.

It will also be appreciated that, although the embodiments primarily disclose the use of detecting particulate contamination, defects or imperfections such as scratches or aberrations on or within the optical components may also be detected by the methods and apparatus of the present invention. And, although the effects of optical surfaces inserted between the LED light source and CIS detector may affect the physics, such as by refraction and diffraction effects, the fundamental concept of the present invention remains unchanged.

While specific embodiments of the invention have been described above, it will be appreciated that the invention may be practiced otherwise than as described. As such, the description is not intended to limit the invention. The configuration, operation, and behavior of the present invention has been described with the understanding that modifications and variations of the embodiments are possible, givin the level of detail present herein. Thus, the preceding detailed description is not meant or intended to, in any way, limit the invention—rather the scope of the invention is defined by the appended claims.

What is claimed is:

1. An apparatus for detecting particles on or defects in a transparent media, comprising:
at least one light source;
a first array of light-sensitive elements in which each of the elements are configured to produce an electrical signal indicating a characteristic value based on light incident on the element, the first array being disposed a predetermined distance from the at least one light source, thereby permitting positioning of the transparent media between the at least one light source and the first array;
an addressing circuit configured to read the characteristic values produced by each element;
an analog-to-digital converter circuit configured to digitize the characteristic values, thereby producing digitized values; and
a processor configured to process the digitized values to determine whether a particle or defect is present,
wherein the at least one light source is configured to produce light to illuminate the particle or defect,
wherein, during detection, the first array receives the light passing through the transparent media and a shadow cast by the particle or defect, and
wherein the processor determines whether the particle or defect is present based at least on a position of the shadow cast by the particle or defect on the first array.

2. The apparatus of claim 1, wherein, when the transparent media is oriented substantially parallel to the array of light-sensitive elements, the particulate or defect occurs on one or more of a top surface of the transparent media, a bottom surface of the transparent media, or within the transparent media.

3. The apparatus of claim 1, wherein the at least one light source emits a continuous light.

4. The apparatus of claim 1, wherein the at least one light source emits a modulated light.

5. The apparatus of claim 1, wherein the at least one light source comprises visible and non-visible electromagnetic radiation.

6. The apparatus of claim 1, wherein the at least one light source comprises two light sources.

7. The apparatus of claim 1, wherein the transparent media comprises at least one optical component.

8. The apparatus of claim 7, wherein the at least one optical component comprises at least one selected from a group comprising a lens, an IR glass, a Bayer filter, and a CIS die.

9. The apparatus of claim 1, wherein the value characteristic is an intensity of the light.

10. The apparatus of claim 6, wherein the processor determines at least one of a location or a size of the particle on or the defect in the transparent media via one or more of the following parameters:
a distance from the two light sources to a top surface of the transparent media, L1;
a distance from a bottom surface of the transparent media to the first array, L2;
a thickness of the transparent media, T;
a size of the first shadow, xₐ-x_{b}, on the first array;
a size of the second shadow, x_{c}-x_{d}, on the first array;
a position of the first shadow on the first array; and
a position of the second shadow on the first array.

11. The apparatus of claim 10, wherein the location or the size of the particle on or the defect in the transparent media is determined via at least the following parameters:
a distance from the light sources to a top surface of the transparent media, L1;
a distance from a bottom surface of the transparent media to the first array, L2;
a thickness of the transparent media, T;
a size of the first shadow, xₐ-x_{b}, on the first array;
a size of the second shadow, x_{c}-x_{d}, on the first array;
a position of the first shadow on the first array; and
a position of the second shadow on the first array.

12. The apparatus of claim 10, further comprising:
at least one second array of light-sensitive elements positioned in relation to the first array to receive light reflected from the particle on or the defect in the transparent media when illuminated by the at least one light source,
wherein at least one of a location or a size of the particle on or the defect in the transparent media is determined via at least one of
a size of a first image associated with the reflected light, xⱼ-xₖ, on the at least one second array, and
a first distance from the at least one light source to the first image on the at least one second array.

13. The apparatus of claim 12, wherein the location or the size of the particle on or the defect in the transparent media also is determined via at least one of
a size of a second image associated with the reflected light, xₗ-xₘ, on the at least one second array, and
a second distance from the at least one light source to the second image on the at least one second array.

14. The apparatus of claim 1, wherein the detection of particulate contamination or defects of transparent media is employed in one or more of optical applications, electronic applications, biological applications, biotechnological applications, fluid applications, or vapor deposited media applications.

15. A method for detecting one or more particles on or defects in a transparent media, comprising:
positioning the transparent media between at least one light source and a first array of light-sensitive elements in which each of the elements are configured to produce electrical signals indicating a value characteristic based on light incident on the element;
illuminating the light source, thereby causing light to pass through the transparent element to cast a light image on the first array and also causing the particle or defect to cast a shadow on the first array;
processing the electrical signals to evaluate whether the particle or the defect is present based at least on a position of the shadow on the first array.

16. The method of claim 15, wherein the at least one light source comprises a first and a second light source and the method further comprises:
illuminating the first light source, thereby causing the particle or defect to cast a first shadow on the first array;
subsequently illuminating the second light source, thereby causing the particle or the defect to cast a second shadow on the first array;
determining at least one of a location or a size of the particle on or the defect in the transparent media via positions of the first and second shadows on the first array.

17. The method of claim 16, wherein the first shadow and the second shadow are cast on different positions of the first array, thereby permitting determination of the location or size of the particle on or the defect in the transparent media.

18. The method of claim 15, wherein the at least one light source is either a point light source or a uniform light source.

19. The method of claim 15, wherein at least one light source emits a continuous light.

20. The method of claim 15, wherein the at least one light source emits a modulated light.

21. The method of claim 16, wherein the first and second light sources are both point light sources.

22. The method of claim 16, wherein the location or size of the particle on or the defect in the transparent media is determined via one or more of the following parameters:
a distance from the light sources to a top surface of the transparent media, L1;
a distance from a bottom surface of the transparent media to the first array, L2;
a thickness of the transparent media, T;
a size of the first shadow, xₐ-x_{b}, on the first array;
a size of the second shadow, x_{c}-x_{d}, on the first array;
a position of the first shadow on the first array; and
a position of the second shadow on the first array.

23. The method of claim 22, wherein the location or size of the particle on or the defect in the transparent media is determined via at least the following parameters:
a distance from the light sources to a top surface of the transparent media, L1;
a distance from a bottom surface of the transparent media to the first array, L2;
a thickness of the transparent media, T;
a size of the first shadow, xₐ-x_{b}, on the first array;
a size of the second shadow, x_{c}-x_{d}, on the first array;
a position of the first shadow on the first array; and
a position of the second shadow on the first array.

24. The method of claim 22, further comprising at least one second array of light-sensitive elements positioned in relation to the first array to receive light reflected from the particle on or the defect in the transparent media when illuminated by the at least one light source, the method further comprising:
determining at least one of a location or size of the particle on or the defect in the transparent media via at least one of
a size of a first image associated with the reflected light, xⱼ-xₖ, on the at least one second array, and
a first distance from the at least one light source to the first image on the at least one second array.

25. The apparatus of claim 24, wherein the location or the size of the particle on or the defect in the transparent media also is determined via at least one of
a size of a second image associated with the reflected light, xₗ-xₘ, on the at least one second array, and
a second distance from the at least one light source to the second image on the at least one second array.

26. The method of claim 15, wherein the transparent media comprises at least one optical component.

27. The method of claim 26, wherein the at least one optical component comprises at least one selected from a group comprising a lens, an IR glass, a Bayer filter, and a CIS die.

28. The method of claim 15, further comprising:
calibrating the first array before processing the electrical signals to evaluate whether the particle or the defect is present based at least on a position of the shadow on the first array.
